(19) United States
(12) Patent Application Publication
(10) Pub. No.: US 2005/0246162 A1
(43) Pub. Date: Nov. 3, 2005

(54) Digital vocal device for multiple purposes

(75) Inventor: Huang Chien-Pang, Taichung City (TW)

Correspondence Address: ANTHONY R. BARKUME, 20 GATEWAY LANE, MANORVILLE, NY, 11949, US

(73) Assignee: Digihorn Technology Corp

(21) Appl. No.: 10/960,672

(22) Filed: Oct. 7, 2004

(30) Foreign Application Priority Data
May 3, 2004 (TW) 093113604

(51) Int. Cl. G10L 11/00

(52) U.S. Cl. 704/200

(57) ABSTRACT

A digital vocal device for multiple purposes comprises a triggering unit and a vocal unit for vocalizing according to the triggering unit, and the feature is: comprising an interface unit, a storage unit, and a control unit. The control unit electrically connects with an external digital device via the interface unit; according to the trigger of the triggering unit, the control unit accesses the voice information from the storage unit to drive the vocal unit to vocalize.

### FIELD OF THE INVENTION

The present invention relates to a digital vocal device, especially to a multiple purposed digital vocal device that is able to vocalize when the respective button is pressed, to provide a storage media to store the vocal information, and to update the vocal information by connecting with a computer via a transferring interface.

### BACKGROUND OF THE INVENTION

The conventional vocal device that is used for alarming or informing purposes, such as a horn of car or a doorbell, is shown in FIG. 1. The traditional vocal device includes a button 10, a relay 11, a power source 12, an amplifier 13, and a horn 14. The operations for the traditional vocal device are: press down the button 10, then the relay 11 will be electrically connected to let the power source 12 provide power to the amplifier 13 for driving the horn 14 to vocalize for alarming or informing; and the horn 14 will stop vocalizing when the button 10 is released.

But, the voice made by the traditional vocal device is always “Bah-Bah” as the horn of a car, or “Ding Dong” as the doorbell, that is very prosy without any customization, and the voice volume is uncontrollable. Such type of alarming or informing voice without any customization cannot provide its original informing purpose for a long time, and also cannot meet the customization requirements from most of the end users in the current market. Therefore, the present invention will try to improve the disadvantage of the traditional technology.

### SUMMARY OF THE INVENTION

The objective of the present invention is to implement a digital vocal device for multiple purposes to vocalize some customized voice whenever the triggering device such as a button is triggered, for example, some special voice effects, speech sounds, or music.

Another objective of the present invention is to have the voice being played and stored in digital format, and to download the preferred voice data from digital devices such as a computer via USB interface, to be stored into a non-volatile storage media for being read and played by an internal micro-controller.

Another objective of the present invention is convenient to usage and installation. A keyboard will also be implemented on the vocal device to control the volume by wired or wireless methods. The vocal device of the present invention not only uses for the horns of cars or motorcycles, but also for the vocal applications of “digital doorbell” or “digital alarm”.

### BRIEF DESCRIPTION OF THE INVENTION

According to the present invention, a digital vocal device for multiple purposes comprises a triggering unit and a vocal unit for vocalizing according to the triggering unit, and the feature is: comprising an interface unit, a storage unit, and a control unit. The control unit electrically connects with an external digital device via the interface unit; according to the trigger of the triggering unit, the control unit accesses the voice information from the storage unto drive the vocal unit to vocalize.

In accordance with one aspect of the present invention, the triggering unit can be a button, a keyboard, a touching device, a vocal controlling device, or a light controllable device.

In accordance with one aspect of the present invention, the vocal device can be a single speaker or several speakers.

In accordance with one aspect of the present invention, the interface unit can be a wired interface or a wireless interface.

In accordance with one aspect of the present invention, the wired interface can be an RS-232, a USB, an IEEE-1394, or a printer port.

In accordance with one aspect of the present invention, the wireless interface can be a blue tooth, a Wi-Fi, or a WAPI.

In accordance with one aspect of the present invention, the storage unit can be a non-volatile memory, a disk, or a CD storage media.

In accordance with one aspect of the present invention, the control unit can be a micro-controller.

In accordance with one aspect of the present invention, the voice information can be sound effects, speech sounds, or music data.

In accordance with one aspect of the present invention, the digital device can be a computer, a PDA (Personal Digital Assistant), or a mobile communication device.

The present invention may best be understood through the following description with reference to the accompanying drawings, in which:

### BRIEF DESCRIPTION OF THE DRAWINGS

FIG. 1 shows the system block diagram of the conventional digital vocal device for alarming or informing purposes;

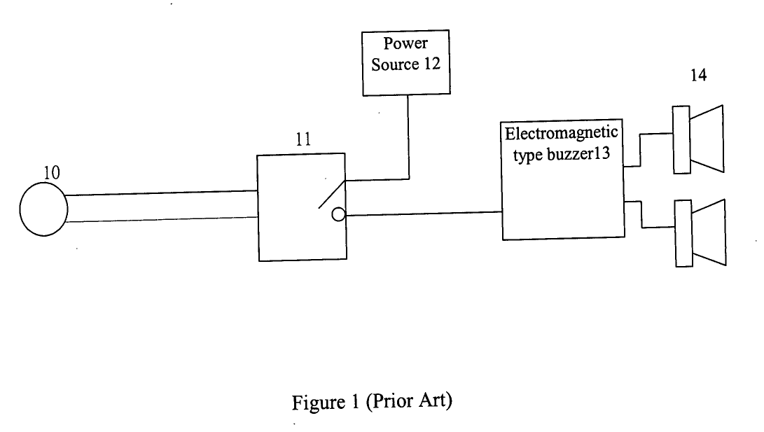

FIG. 2 shows the system block diagram of the digital vocal device for multiple purposes in the preferred embodiment according to the present invention;

FIG. 3 shows another preferred embodiment according to the present invention; and

FIG. 4 shows the other preferred embodiment according to the present invention.

### DETAILED DESCRIPTION OF THE PREFERRED EMBODIMENT

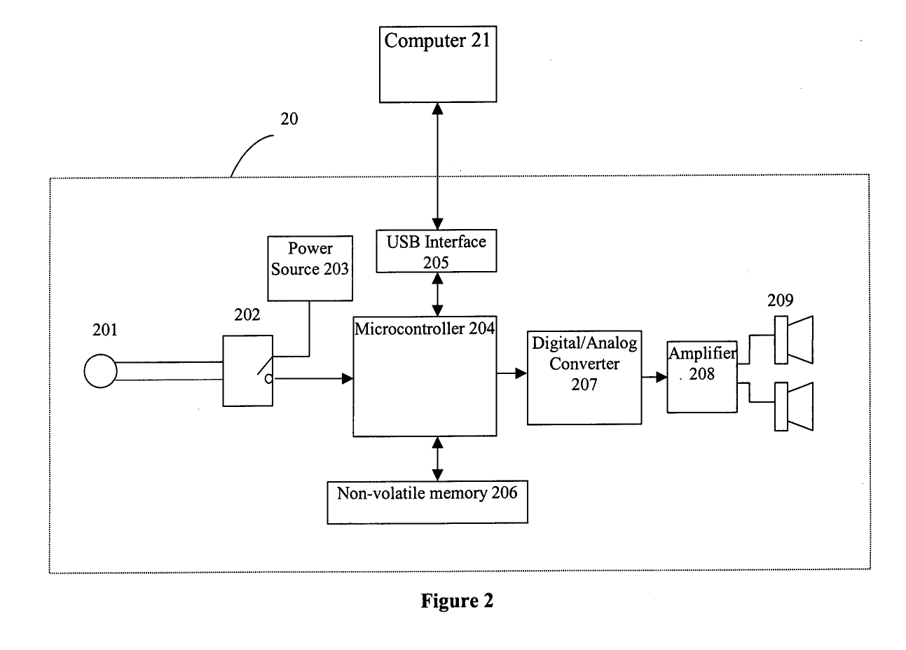

FIG. 2 shows the system block diagram of the digital vocal device for multiple purposes according to the present invention. In the diagram, the vocal device 20 includes a button 201, a relay 202, a speaker power source 203, a micro-controller 204, a USB interface 205, a non-volatile memory 206, an ADC (Analog to Digital Converter) 207, an amplifier 208, and a speaker 209. In which, the button 201 is a triggering unit and has a trigger action when the button 201 is pressed; the micro-controller 204 is a the control unit; the USB Interface 205 is an interface unit, which is able to connect with an external digital device, such as the computer 21; the non-volatile memory 206 is a memory unit, which is for storing sound effects, speech sounds, or music data; the speaker 209 is a vocal unit for playing the voice information.

The operations for the vocal device 20 are: when the button 201 is pressed, the relay 202 electrically connects with the power source 203 to drive the micro-controller 204 to access the voice information from the non-volatile memory 206; the voice information is digital signals, and will be transferred to analog signals by DAC 207 (Digital to Analog Converter) and play once or continuously by the speaker 209 through the amplifier 18; and the speaker 209 will stop playing when the button 201 is released.

In order to let the vocal device 20 to vocalize multiple voices, the voice information stored in the non-volatile memory 206 can be updated. The vocal device 20 is controllable by the micro-controller 204 to connect with the computer 21 through the USB interface 205, and to download any type of voice information from the computer 21 to store into the non-volatile memory 206. The non-volatile memory 206 is able to keep all the downloaded voice information forever without power supplied. The voice information source can be provided by the PC recording, internet downloading, or the CD-ROM with many voices.

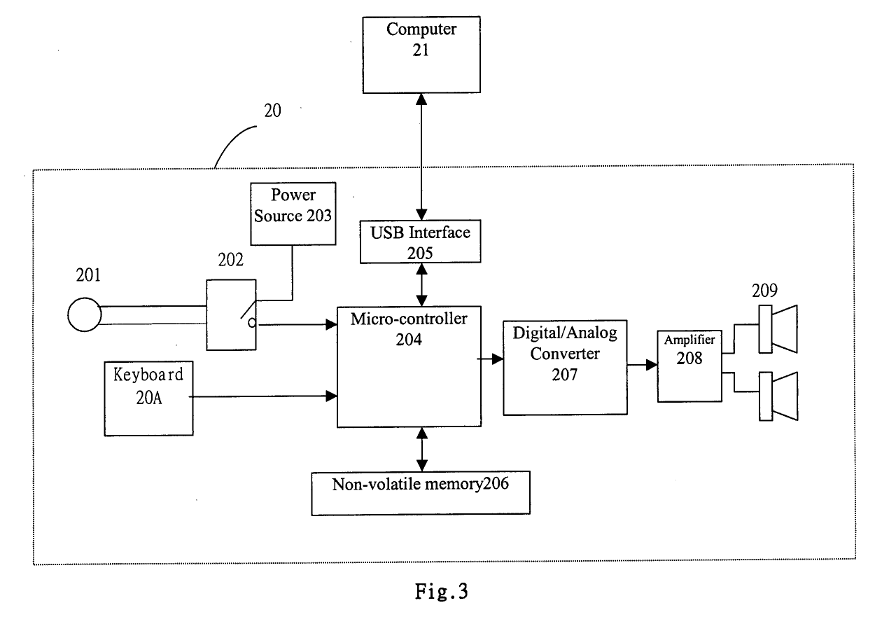

FIG. 3 shows another preferred embodiment according to the present invention. In the diagram, the vocal device 20 also comprises the keyboard 20A as an input unit for selecting any one of the voice information from the non-volatile memory 206. When the button 201 is pressed, the micro-controller 204 will be able to access the corresponding voice information from the non-volatile memory 206 and let the voice information be played by the speaker 209. Or, using the keyboard 20A as a triggering unit and let the micro-controller 204 read any one of the several voices from the non-volatile memory 206 to be played by the speaker 209 whenever one of the keys of keyboard 20A is pressed. Furthermore, if the keyboard 20A supports the function for pressure detecting, then this vocal device is able to control the volume and play time of the speaker ??206??. For example, the tighter we press the buttons the louder voice will be played; the longer we press the buttons the longer voice will be played.

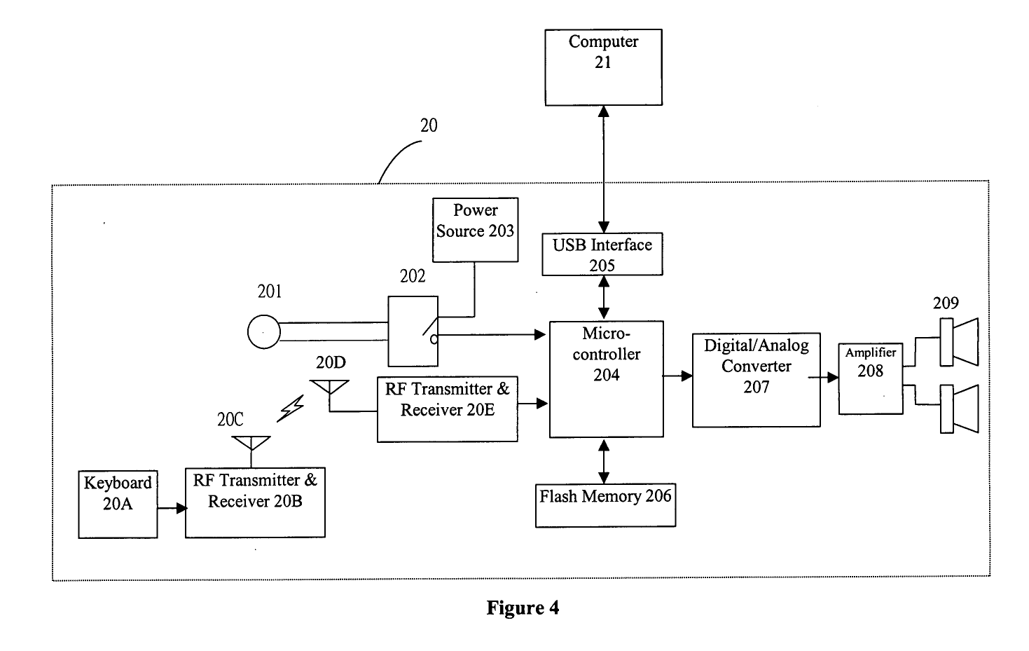

Please refer FIG. 4, which is the other better execution example according to the present invention. In this diagram, RF transceiver 20B and an antenna 20C are implemented on the keyboard 20A, and an RF transceiver 20D and an antenna 20E are implemented on the micro-controller 204, those are able to let Keyboard 20A transfer input data to the micro-controller 204 by wireless communication method.

Of course, not only button but also a triggering device, a voice controlling device, or a light controllable device can be used as a triggering unit. Secondly, the interface unit can be a wired USB interface, an IEEE-1394, or RS-232 serial port, a printer parallel port, or a blue tooth, a Wi-Fi, a WAPI wireless interface. Furthermore, the storage unit can be a non-volatile memory or the other non-volatile memory, or using disk or CD-ROM for saving voice information.

For application, the vocal device in the present invention can be implemented on a car or a motorcycle to vocalize sound effects, speech sounds, or music for alarming in addition to “Bah Bah”. If we are bored with the original sound effects, new voice information can be downloaded from a connected digital device such as a computer through the transferring interface. Excepting to be implemented on a car for alarming, the vocal device of the present invention can be used on the doorbell or the other alarming or informing devices, to support several and updated sound effects.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A digital vocal device for multiple purposes having a triggering unit and a vocal unit for vocalizing according to a triggering unit, and comprising an interface unit, a storage unit, and a control unit; said control unit electrically connecting with an external digital device via said interface unit; according to said trigger of said triggering unit, said control unit accessing said voice information from said storage unit to drive said vocal unit to vocalize.

2. The device according to claim 1 wherein said triggering unit can be a button, a keyboard, a touching device, a vocal controlling device, or a light controllable device.

3. The device according to claim 1 wherein said vocal device can be a single speaker or several speakers.

4. The device according to claim 1 wherein said interface unit can be a wired interface or wireless interface.

5. The device according to claim 4 wherein said wired interface can be RS-232, a USB, an IEEE-1394 or a printer port.

6. The device according to claim 4 wherein said wireless interface can be a blue tooth, a Wi-Fi or a WAPI.

7. The device according to claim 1 wherein said storage unit can be a non-volatile memory, a disk or a CD storage media.

8. The device according to claim 1 wherein said control unit can be a micro-controller.

9. The device according to claim 1 wherein said voice information can be sound effects, speech sounds or music data.

10. The device according to claim 1 wherein said digital device can be a computer, a PDA (Personal Digital Assistant) or a mobile communication device.
